(19) United States
(12) Patent Application Publication
(10) Pub. No.: US 2005/0136710 A1
(43) Pub. Date: Jun. 23, 2005

(54) Female Terminal for Inserting in a Printed Circuit Board

(75) Inventor: Jordi Marti Adell, Valls (ES)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/707,554

(22) Filed: Dec. 20, 2003

(51) Int. Cl. H01R 12/00

(52) U.S. Cl. 439/81

(57) ABSTRACT

Disclosed is a female terminal for mounting on a printed circuit board comprising two resilient arms or tabs, beveled on their inner portion and facing each other, between which various types of components can be electrically connected, and having one or more pins to be inserted in one or more bores of a printed circuit board. The female terminal of the present invention is provided with two support projections susceptible to cooperating with an insertion tool for insertion of said female terminal onto said printed circuit board, and said pins having a size and shape in relation to the diameter or cross section of said bores such that, once inserted in said bores, said female terminal is fixed and arranged on the board prior to welding said pins to said printed circuit board.

### BACKGROUND OF INVENTION

1. Field of the Invention

The present invention relates to a female terminal for inserting in a printed circuit board. More particularly the present invention relates to a female terminal that facilitates inserting, fixing and aligning thereof in a circuit board by means of an insertion tool. Said female terminal serves to connect various types of electronic components through it to a printed circuit board.

2. Description of the Related Art

Document FR-A-2813711 discloses a flat terminal provided with two resilient projections or tabs between which an automotive fuse is inserted. On one of these tabs, there is a projection acting as a stop for a pin that said fuse is provided with, thus defining the insertion depth. A pair of said terminals is partly covered by a casing acting as a guide for the fuse. However, no special feature in the terminal is pointed out in said document for facilitating its insertion by means of a tool designed for that purpose, and although the set of two terminals covered by said casing will be arranged on a printed circuit board prior to welding pins existing therein, this is not the case for a single terminal, since at no time is it indicated that there is no allowance between said pins and bores of said board in which the pins will be inserted.

European patent application EP-A-1235245 discloses a fuse holder module which integrates two flat terminals similar to those provided by the present invention. It also points out the possibility that several pins existing in said terminals fit in bores of a printed circuit board, and therefore fix themselves on the board, without being welded. However, said terminals are partially arranged inside of a casing, forming with said casing said module, and the separate use thereof is not indicated in said application, nor does it indicate any special feature in the terminal for facilitating its insertion by means of a tool designed for that purpose.

The need exists to provide a female terminal which is fixed and arranged on a printed circuit board prior to being welded, and whose features facilitate its insertion therein.

### DISCLOSURE OF THE INVENTION

The present invention satisfies said need by providing a female terminal for insertion thereof in a printed circuit board, which is provided with two resilient projections or tabs between which several types of components, particularly passive components such as fuses, can be inserted, and one or more pins to be inserted in one or more bores of a printed circuit. Said terminal comprises two support projections susceptible to collaborating with a manipulation tool for their insertion in said board, and said pins have a size and shape such that, in relation to the diameter or cross section of said bores, they fix and arrange said terminal on said board prior to welding said pins to said printed circuit.

### BRIEF DESCRIPTION OF DRAWINGS

FIG. 1 shows a perspective view of the female terminal of a preferred embodiment of the present invention.

FIG. 2 shows a perspective view of a pair of the female terminals shown in FIG. 1, inserted facing each other in a printed circuit board, and having a fuse introduced between them.

FIG. 3 shows an upper perspective view of two of the female terminals shown in FIG. 1, inserted adjacently in a printed circuit board with a track arranged between the pins of said two female terminals.

FIG. 4 shows a lower view of the assembly of FIG. 3.

FIG. 5 shows a perspective view of a insertion tool at the time of inserting a female terminal, like the one shown in FIG. 1, from a strip of said female terminals.

FIG. 6 shows a view of the tool shown in FIG. 5 once said terminal has been inserted.

### DETAILED DESCRIPTION

The preceding features as well as other features of the invention will become clearer after the following description of a preferred embodiment which is illustrated in the drawings and which is to be taken as illustrative and non-limiting.

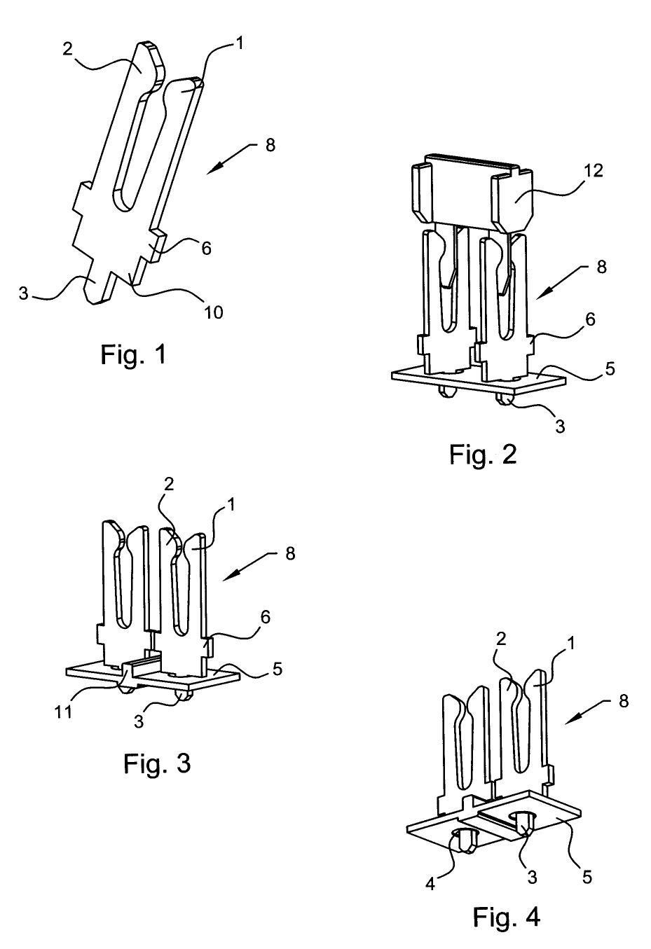

FIG. 1 shows the female female terminal 8 for inserting into a printed circuit printed circuit board 5 according to the present invention. Said female female terminal 8 comprises two resilient arms or tabs 1 and 2, beveled on their inner portions and facing each other in edgewise orientation, between which several types of components, particularly passive components such as fuses, can be inserted, and one or more pins 3, depending on the electrical current intensity which is to pass through them, to be inserted in one or more corresponding bores 4 of said printed circuit printed circuit board 5 (see FIGS. 4, 5 and 6).

FIG. 2 shows an assembly of the present invention in which two terminals 8 are arranged in shunt, facing each other, and inserted in said printed circuit printed circuit board 5, with a fuse 12 inserted between them, said terminals 8 therefore acting as respective continuations of the respective electrical contacts of said fuse 12.

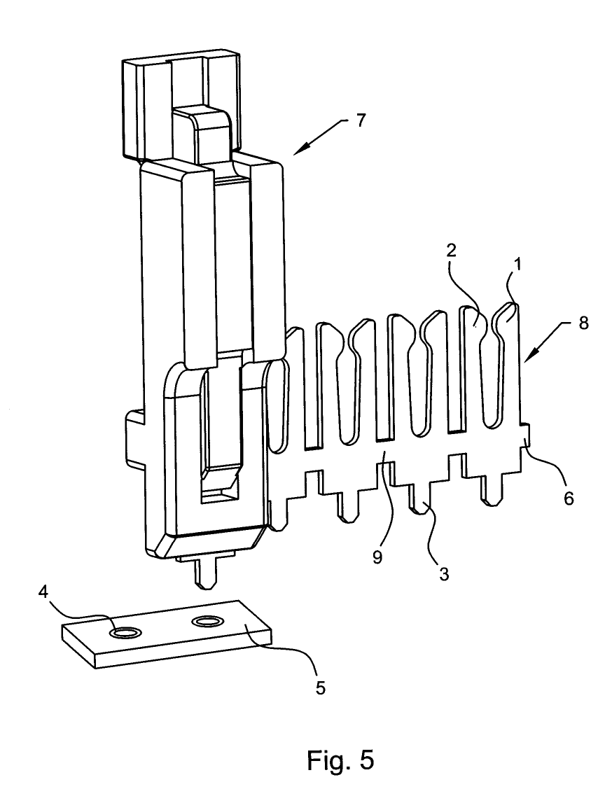

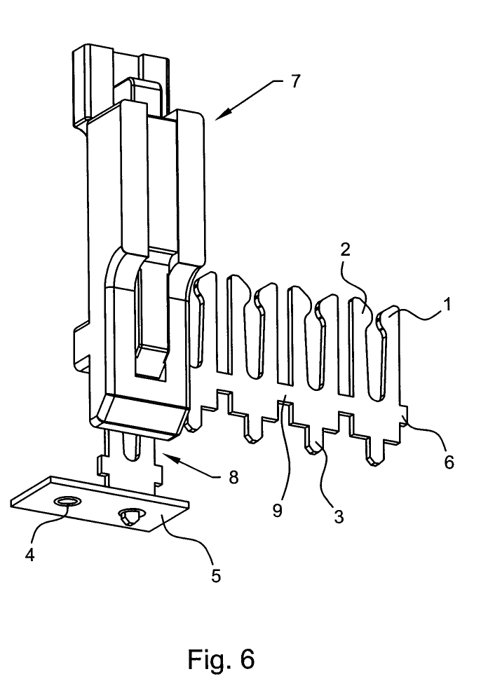

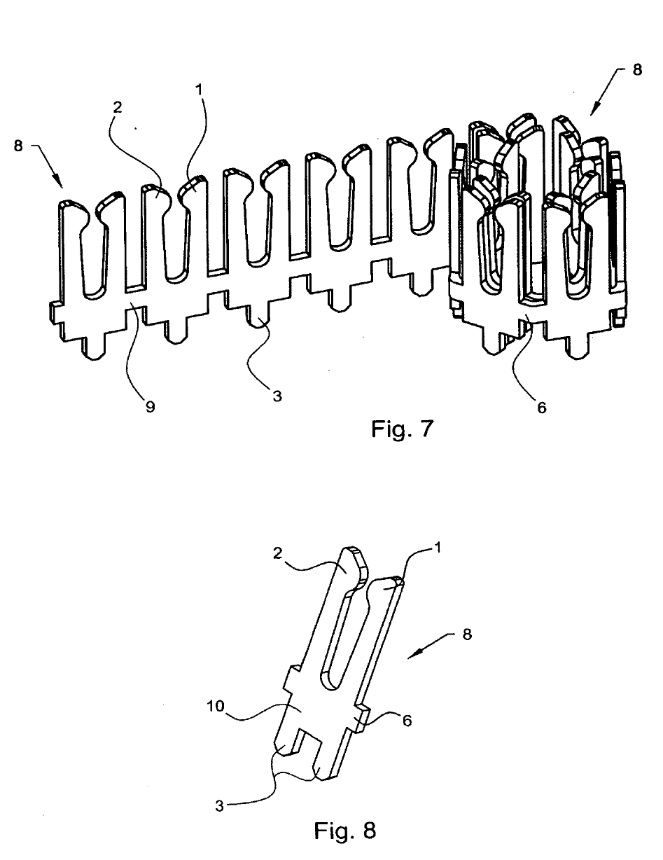

The female terminal 8 is provided with two support projections 6, which can be seen in all the attached figures, susceptible to cooperating with a insertion tool 7 (see FIGS. 5 and 6) for inserting said female terminals 8 into said circuit printed circuit board 5. The individual female terminals 8 being formed by cutting them from a strip 9 which previously connected a plurality of said female terminals 8 to one another, as shown in FIGS. 5 and 6. Said insertion tool 7 not only inserts the female female terminal 8 into the printed circuit board 5 through said bores 4, but it is also responsible for carrying out the cutting of said connection strip 9 between individual female terminals 8. In another embodiment (not shown), said cutting being carried out by means other than the one explained and independent of the insertion step. Said connected female terminals 8 are also connected, by connection strips 9, to other female terminals 8, these female terminals 8/connection strips 9 assemblies forming a coil-shaped wound band.

The function of said support projections 6 is not only that of collaborating with said insertion tool 7, but also to allow the passage of conductor tracks or conductor bridges 11 between them and the printed circuit printed circuit board 5 once said female terminal 8 is inserted in said printed circuit printed circuit board 5. Specifically the distance between support projections 6 and shoulders 10 of female terminal 8 provides a space between said support projections 6 and the surface of said printed circuit printed circuit board 5. Said shoulders 10 arranged on the lower portion of the female terminal 8 act as a stop with the printed circuit printed circuit board 5 during the insertion process.

Once the female terminal 8 has been inserted in the printed circuit printed circuit board 5 through the bore 4, and before welding pins 3 to said printed circuit board 5, the terminal 8 is already fixed and correctly arranged on said printed circuit board 5. This is because of the size and shape of said pins 3, which make them fit in the bores 4 without leaving any allowance between the holes and pins 3. Said fit also occurs because the cross section of said pin 3 is inscribed within a circumference of diameter which is slightly bigger than the diameter of the bore 4 and is beveled on the ends so as to facilitate the positioning of the female terminal 8. This fit and positioning prior to the welding can be seen in FIGS. 4, 5 and 6.

As has been previously explained, the tabs 1, 2 of the female terminal 8 of the present invention are resilient, which allows components with pins of different thickness to be inserted between them. However, the distance between said tabs 1, 2 can be any desired distance, depending on the application for which the female terminals 8 are intended, and/or depending on the desired component to be inserted between them.

Likewise, the material comprising female terminal 8 may be chosen according to the resilience conditions desired for said tabs 1, and 2, and the electric conductivity desired for the entire female terminal 8.

Although the preferred embodiments of the present invention have been disclosed, various changes, and modifications may be made without departing from the scope of the invention as set forth in the appended claims.

1. (canceled)

2. A flat female terminal according to claim 19 wherein, said at least two pins each have a width slightly larger than the diameter of a complimentary bores on a circuit board.

3. A flat female terminal according to claim 2 wherein, said at least two pins are beveled on their ends.

4. A flat female terminal according to claim 19 wherein, a plurality of said flat female terminals (8) are connected in a ribbon by projection areas (9) forming a continuous coil-shaped wound band of said flat female terminals (8).

5. A flat female terminal according to claim 4 wherein, said projections are formed by cutting a single flat female terminal from a strip of connected flat female terminals.

6. (canceled)

7. A flat female terminal according to claim 19 wherein, said at least two pins, comprises a plurality of pins the number of which is based on the electrical current load to be carried by said pins.

8. A flat female terminal according to claim 19 wherein, the distance of the spaced relationship between said arms is selected according to the type of component to be inserted between them.

9. A flat female terminal according to claim 19 wherein, said terminal is comprised of a material having a desired resiliency and a desired electrical conductivity.

10. (canceled)

11. A flat female terminal according to claim 20 wherein, said at least two pins each have a width slightly larger than the diameter of complimentary bores on a circuit board.

12. A flat female terminal according to claim 11 wherein, said at least two pins are beveled on their ends.

13. A flat female terminal according to claim 20 wherein, a plurality of said flat female terminals are connected in a ribbon by the projection areas of said body portions forming a continuous coil-shaped wound band of said flat female terminals.

14. A flat female terminal according to claim 13 wherein, said projections are formed by cutting a single flat female terminal from a strip of connected flat female terminals.

15. (canceled)

16. A flat female terminal according to claim 20 wherein, said at least two pins comprise a plurality of pins the number of which is based on the electrical current load to be carried by said pins.

17. A flat female terminal according to claim 20 wherein, the distance of the spaced relationship between said arms is selected according to the type of component to be inserted between them.

18. A flat female terminal according to claim 20 wherein, said terminal is comprised of a material having a desired resiliency and a desired electrical conductivity.

19. A flat female terminal for inserting in a printed circuit board for mounting electrical components comprising:
a body portion having two ends and two sides comprising:
two resilient arms in spaced relationship located on one end of said body portion, said arms being beveled on their inner portion and said inner portion of each of said resilient arms facing each other;
at least two pins located on the end of said body portion opposite said two resilient arms said at least two pins being suitable for inserting into a complimentary bores on a printed circuit board, said at least two pins being further characterized as having a shape the end of which is dimensioned smaller than the complimentary bores of a printed circuit board and said pins dimensioned to provide a tight friction fit between said at least two pins and said complimentary bores on said printed circuit board; and
a support projection located on each side of said body portion suitable for interacting with a female terminal insertion tool for mounting said female terminals in a printed circuit board.

20. A flat female terminal for inserting in a printed circuit board for mounting electrical components comprising:
a body portion having two ends and two sides comprising:
two resilient arms in spaced relationship located on one end of said body portion, said arms being beveled on their inner portion and said inner portion of each of said resilient arms facing each other;
at least two pins located on the end of said body portion opposite said two resilient arms said at least two pins being suitable for inserting into a complimentary bores on a printed circuit board, said at least two pins being further characterized as having a shape the end of which is dimensioned smaller than the complimentary bore of a printed circuit board and said pins dimensioned to provide a tight friction fit between said at least two pins and said complimentary bores on said printed circuit board;
a support projection located on each side of said body portion suitable for interacting with a female terminal insertion tool for mounting said female terminals in a printed circuit board; and
a shoulder located on each side of said body portion at said end having said at least one pin mounted thereto having a dimension greater than the said at least one pin and less than the dimension of said support projection thereby providing a space between the printed circuit board and said support projections allowing for the introduction of conductor bridges and the like.
